(19) United States
(12) Patent Application Publication
(10) Pub. No.: US 2010/0067486 A1
(43) Pub. Date: Mar. 18, 2010

(54) HANDOVER METHOD IN WIRELESS LAN SYSTEM AND APPARATUS USED IN HANDOVER METHOD

(75) Inventor: Hiroyo Masuda, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/494,729

(22) Filed: Jun. 30, 2009

(30) Foreign Application Priority Data
Sep. 12, 2008 (JP) 2008-235722

(51) Int. Cl. H04W 36/00

(52) U.S. Cl. 370/331

(57) ABSTRACT

When a mobile station moves from a communication area of a first access point to a communication area of a second access point, an information processing device provided for the second access point functions as an extraction device, a request device, and a communication device. The extraction device extracts first access point identification information identifying the first access point from a connection request message received from the mobile station. The request device requests the first access point to transmit the control information relating to the communication of the mobile station using the first access point identification information. The communication device establishes a link to the mobile station using the control information acquired from the first access point.

### CROSS-REFERENCE TO RELATED APPLICATION

This application is based upon and claims the benefit of priority of the prior Japanese Patent Application No. 2008-235722, filed on Sep. 12, 2008, the entire contents of which are incorporated herein by reference.

### FIELD

The embodiments discussed herein are related to the handover performed in a network system using a wireless LAN.

### BACKGROUND

A mobile station which performs communications through a WLAN (wireless local area network) appropriately performs handover depending on the communication quality of a signal received from an access point (base station, AP). FIG. 12 is an example of sequence diagram illustrating the operations performed by a mobile station in handover between access points.

(1) In performing handover, a mobile station (STA) transmits a probe request message (Probe REQ) to inquire about the presence/absence of access points in the vicinity. When the mobile station receives a probe response message (Probe RES) from an access point, an authenticating process is performed between the mobile station and the access point that has transmitted the probe response message.

(2) The mobile station defines an authenticated access point as an access point (new access point) to which the handover is performed, and transmits a re-association request message (Re-association REQ) to the new access point.

(3) Upon receipt of the re-association request message, the new access point attempts to establish a connection to the mobile station. To obtain information for the establishment of the connection, the new access point transmits a re-association request message to a wireless control device (WLS) that controls the new access point.

Upon receipt of the re-association request message, the wireless control device determines a mobile station which performs the handover. The wireless control device also determines the access point that is currently connected by the mobile station (old access point), and communicates with the old access point.

When the mobile station is determined, the wireless control device includes the information for the communication with the mobile station such as a common key to be used on the communication with the mobile station in a re-association response message (Re-association RES) as a response to the re-association message, and transmits the message to the new access point. The new access point establishes a connection to the mobile station using the received control information.

As the technology relating to the handover between access points performed by a mobile station, a method of selecting a wireless LAN base station to be connected to a wireless LAN terminal station for the wireless LAN terminal station belonging to the communication areas of a plurality of wireless LAN base stations is disclosed. In this method, a wireless LAN base station to be connected is selected on the basis of the electric field strength of a signal transmitted from the wireless LAN base station and the communication quality. Another document discloses the system of a sub unit acquiring AP information by executing search of the peripheral AP and holding the latest information about the peripheral AP that connectable as a roaming destination in an AP information table. In addition, the system of determining a second access point for a succeeding communication on the basis of the radio wave intensity during the communication of a portable communication terminal with a first access point. Furthermore, there is also a document disclosing a network service connection system using the association among a service, a service vendor for offering a service, and a V-LAN switch.

[Patent Document 1] Japanese Laid-open Patent Publication No. 2005-244721

[Patent Document 2] Japanese Laid-open Patent Publication No. 2004-88592

[Patent Document 3] Japanese Laid-open Patent Publication No. 2007-311851

[Patent Document 4] Japanese Laid-open Patent Publication No. 2004-363878

In the above-mentioned handover method, a new access point requests a wireless control device controlling the new access point for information for the communications with a mobile station. The information requested by the new access point is held in a wireless control device controlling an old access point. Therefore, when a new access point and an old access point are subordinate to different wireless control devices, the wireless control device of the new access point cannot access the old access point etc., and the new access point cannot acquire control information for communications. Accordingly, when the new access point and the old access point are controlled by different wireless control devices, the handover cannot be successfully performed, and the communications of a mobile station fail. In this case, the mobile station once disconnects a connection and newly makes a connection to the new access point.

### SUMMARY

According to an aspect of the invention, when a mobile station moves from a communication area of a first access point to a communication area of a second access point, an information processing device provided for the second access point functions as an extraction device, a request device, and a communication device. The extraction device extracts first access point identification information identifying the first access point from a connection request message received from the mobile station. The request device requests the first access point to transmit the control information relating to the communication of the mobile station using the first access point identification information. The communication device establishes a link to the mobile station using the control information acquired from the first access point.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an example of the configuration of the network in which a handover method according to an embodiment of the present invention is used;

FIG. 2 is a sequence diagram illustrating an example of an embodiment of the handover method when a new access point and an old access point are not subordinate to the same wireless control device;

FIG. 3 is a diagram illustrating an information element of a probe request message;

FIG. 4 is a diagram illustrating an information element of a re-association request message;

FIG. 5A is a diagram illustrating the configuration of the SSID;

FIG. 5B is a diagram illustrating the configuration of the SSID that can be used in transmitting and receiving access point identification information;

FIG. 6 is a sequence diagram illustrating an example of an embodiment of the handover method used when control information is acquired by a new access point through an old access point;

FIG. 7 is an example of an AP-ID table stored by an access point;

FIG. 8 is a diagram illustrating an example of an access point management table;

FIG. 9 is a diagram illustrating a method of acquiring access point identification information about an access point to be connected when a mobile station starts communications with a network;

FIG. 10 is a diagram illustrating an example of the configuration of a mobile station compatible with the handover method according to an embodiment of the present invention;

FIG. 11 is a diagram illustrating an example of the configuration of an access point compatible with the handover method according to an embodiment of the present invention; and

FIG. 12 is an example of sequence diagram illustrating the operations performed by a mobile station in handover between access points.

### DESCRIPTION OF EMBODIMENTS

### Example of Configuration of a Network

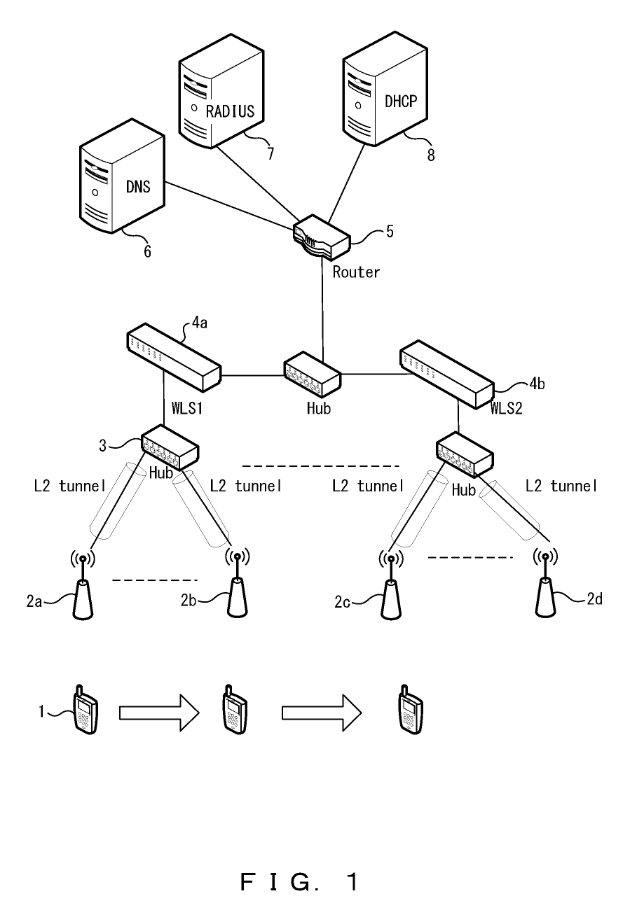

FIG. 1 is an example of the configuration of the network in which a handover method according to an embodiment of the present invention is used. A mobile station 1 performs a communication with another node through an access point 2 (AP, base station), and the mobile station 1 may use a common key etc. during the communication. Each wireless control device 4 (4a, 4b) manages a plurality of access points 2 (2a through 2d). In FIG. 1, the access points 2a and 2b are managed by the wireless control device 4a, and the access points 2c and 2d are managed by the wireless control device 4b. Therefore, when the mobile station 1 moves from the communication area of the access point 2b to the communication area of the access point 2c, a handover process is performed between the access points 2 managed by different wireless control devices.

In addition, the wireless control device 4 stores information for the communication with the mobile station 1. An example of the information for the communication with the mobile station 1 can be, for example, a common key used for communications with the mobile station 1. The access point 2 and the wireless control device 4 are connected through a hub 3, and a plurality of wireless control devices 4 are connected to a router 5 through the hub 3.

Each node of a network can communicate with a DNS (domain name system) server 6, a RADIUS (remote authentication dial in user service) server 7, and a DHCP (dynamic host configuration protocol) server 8 through the router 5. By communicating with these servers, appropriately a domain name can be associated with an IP address, authentication can be recorded, and an address can be assigned to a temporarily connected node.

The network configuration illustrated in FIG. 1 is only an example, and the number of access points 2 managed by each wireless control device 4 and the number of wireless control devices 4 connected to one router 5 are optionally determined.

<Handover Method>

If a new access point can acquire control information used by an old access point in the communication with a mobile station, the handover can be performed although the new access point and the old access point are subordinate to different wireless control devices. As one embodiment, the new access point may access the wireless control device managing the old access point to acquire control information and perform the handover.

Then, a master wireless control device managing all wireless control devices 4 can be provided on a network, and the new access point 2 can access the wireless control device 4 managing the old access point using the information about the master wireless control device. The master wireless control device holds a database recording the connection relation to the access point 2 using the MAC address (media access control address) for the wireless control device 4.

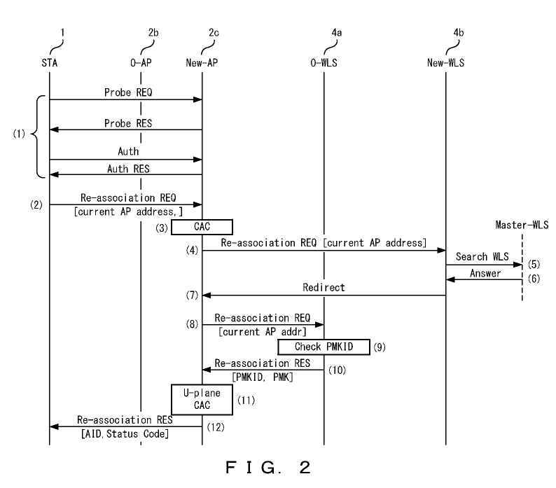

FIG. 2 is a sequence diagram illustrating an example of an embodiment of the handover method when a new access point and an old access point are not subordinate to the same wireless control device. Described below is an example of the handover when the mobile station 1 moves from the communication area of the access point 2b to the communication area of the access point 2c.

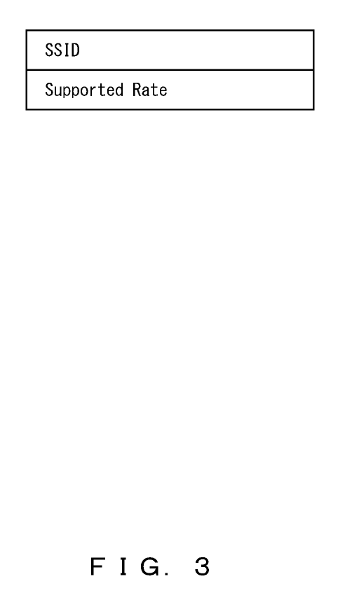

(1) The mobile station 1 transmits a probe request message to know the communication area located close to the mobile station 1 when the handover is performed. FIG. 3 is a diagram illustrating an information element of a probe request message. A probe request message includes an SSID (service set identifier) and a supported rate. The supported rate is a list of all wireless transmission rates supported by the mobile station 1. After receiving the probe request message, the access point 2c transmits a probe response message to the mobile station 1 to notify that the mobile station 1 is located in the communication area of the access point 2c. When the mobile station 1 recognizes the access point 2c according to the probe response message, the mobile station 1 and the access point 2c exchanges an authenticating message (Auth message or Auth RES message) to perform authentication.

(2) The mobile station 1 defines the authenticated access point 2c as a new access point, and transmits a re-association request message (Re-association REQ). The re-association request message is a message for requesting the new access point to make a connection when the mobile station 1 performs the handover.

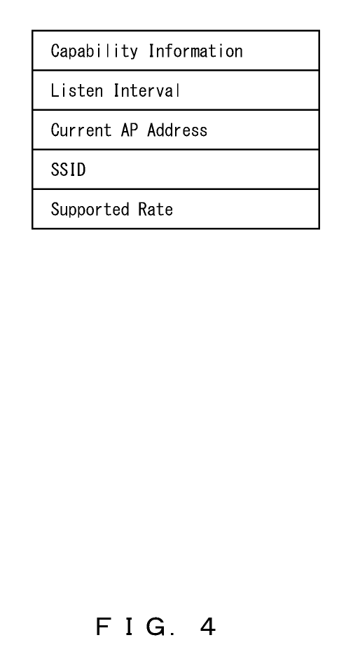

FIG. 4 is a diagram illustrating an information element of a re-association request message. The re-association request message includes, in addition to the SSID, Capability Information, Listen Interval, Current AP Address, etc. Capability Information indicates various types of information. For example, Capability Information indicates whether the mobile station 1 has an adaptive contention free period. Listen Interval indicates a period in which a mobile station receives a beacon. Current AP Address indicates a MAC address of the access point 2b.

(3) Upon receipt of a re-association request message, the new access point 2c performs call admission control (CAC) and confirms whether the number of mobile stations 1 to be connected to the access point 2c can be increased.

(4) When one or more mobile stations can be connected to the access point 2c, the access point 2c transmits a re-association request message to the wireless control device 4b managing the access point 2c. The access point 2c requests the wireless control device 4b to transmit the address of the wireless control device 4a by transmitting the re-association request message. At this time, the access point 2c notifies the wireless control device 4b of the MAC address of the old access point 2b as information for retrieving the wireless control device 4 managing the old access point 2b.

(5) Upon receipt of the re-association request message, the wireless control device 4b inquires of the master wireless control device about the wireless control device 4 managing the access point 2b. At this time, the wireless control device 4b notifies the master wireless control device of the MAC address of the access point 2b.

(6) The master wireless control device searches a database using the notified MAC address, and recognizes that the wireless control device 4 managing the access point 2b is the wireless control device 4a. The master wireless control device notifies the wireless control device 4b which requested the retrieval of the management of the old access point 2b by the wireless control device 4a and the MAC address of the wireless control device 4a.

(7) Upon receipt of the notification from the master wireless control device, the wireless control device 4b transmits a Redirect message to the access point 2c, thereby notifying that the access point 2c is to access the wireless control device 4a to acquire control information.

(8) The new access point 2c transmits a re-association request message to the wireless control device 4a and notifies the device of the MAC address of the old access point 2b.

(9) The wireless control device 4a retrieves control information for the communication with the mobile station 1 using the MAC address of the old access point 2b. The control information includes, for example, a PMKID (pairwire master key identifier) etc. used in the communications.

(10) The wireless control device 4a transmits a re-association response message to notify the new access point 2c of the PMKID and a PMK (pairwire master key).

(11) The new access point 2c performs call admission control on the U-plane, and the access point 2c confirms whether the number of the mobile stations 1 transmitting and receiving user data can be increased.

(12) The new access point 2c transmits the re-association response message to the mobile station 1. The re-association response message includes AID (Association Identifier) and Stetus Code. AID is an identifier of the mobile station 1 assigned by the access point 2c to the mobile station 1, and Stetus Code is the information about whether the access point 2c and the mobile station 1 can establish a link.

By using the above-mentioned handover method, the handover can be performed between the access points connected to different wireless control devices. However, since a master wireless control device retrieves an old access point when a new access point receives a re-association request message etc., there occurs the problem that a load of a master wireless control device increases. In addition, since the master wireless control device takes time to perform the process of retrieving the old access point, there also occurs the problem of additional time required to perform the process.

As another embodiment of improving the above-mentioned problems, a new access point can acquire control information used in the communications between an old access point and a mobile station through the old access point. In this case, each access point is provided with an AP-ID table recording access point identification information (AP-ID) designating each access point about the access points provided near itself. When the mobile station notifies the new access point of the access point identification information about the old access point, the new access point designates the MAC address etc. of the old access point using the AP-ID table. The new access point requests the old access point to transmit control information, and establishes a link to the mobile station according to the acquired control information. In this embodiment, the handover can be performed between the access points 2 connected to different wireless control devices without a load imposed in a specific node such as a master wireless control device etc.

Setting access point identification information and storing an AP-ID table in the access point 2 can be performed when the access point 2 and the wireless control device 4 are provided. In addition, when the access point 2 is added etc., the AP-ID table of each access point 2 can be set or changed through the wireless control device 4. The AP-ID table records access point identification information identifying the access point 2 that can be the old access point 2 in the handover in which the access point 2 holding the AP-ID table is defined as a new access point. However, depending on the embodiment of the access point 2, access point identification information about other access points 2 can be held in the AP-ID table. For example, the access point identification information about all access points 2 provided in the network can be stored depending on the size of the network and the storage capacity of the access point 2. That is, the AP-ID table provided for a first access point 2 can be arbitrarily configured to include the access point identification information indicating at least a second access point 2 forming the communication area adjacent to the communication area of the first access point 2.

The access point identification information can be the information that uniquely identifies each access point 2 included in the table in the AP-ID table provided for each access point 2, and can be arbitrarily configured. For example, it can be a serial number assigned using a certain access point 2 as a base point.

The access point identification information can be transmitted and received between a mobile station and an access point using the information element of an existing message. For example, the access point identification information can be transmitted and received using a field assigned to the SSID included in the message transmitted and received between a mobile station and an access point etc.

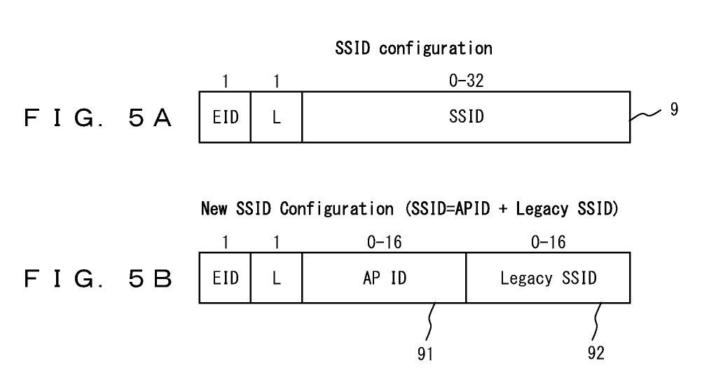

FIGS. 5A and 5B are diagrams illustrating the configuration of the SSID that can be used in transmitting and receiving access point identification information. SSID is an identifier used in identifying a service. As illustrated in FIG. 5A, an SSID field 9 has a length of 32 octets or less. As illustrated in FIG. 5B, a part of the SSID field 9 is divided into an access point identification information field 91 of a length of 16 octets or less and an SSID field 92 of a length of 16 octets or less. The access point identification information field 91 can store the access point identification information, and the SSID field 92 can store the identifier used in identifying a service corresponding to the SSID originally stored in the SSID field 9. The access point identification information can be notified by configuring the SSID included in the message transmitted and received between the mobile station and the access point as illustrated in FIG. 5B.

Upon receiving a message including SSID provided with the access point identification information field 91, a node that received the message refers to the access point identification information field 91 when the node acquires the access point identification information. On the other hand, when a service is identified, the node processes the information stored in the SSID field 9 in the SSID illustrated in FIG. 5A. Therefore, each node masks the access point identification information field 91, and performs the process using the SSID field 92.

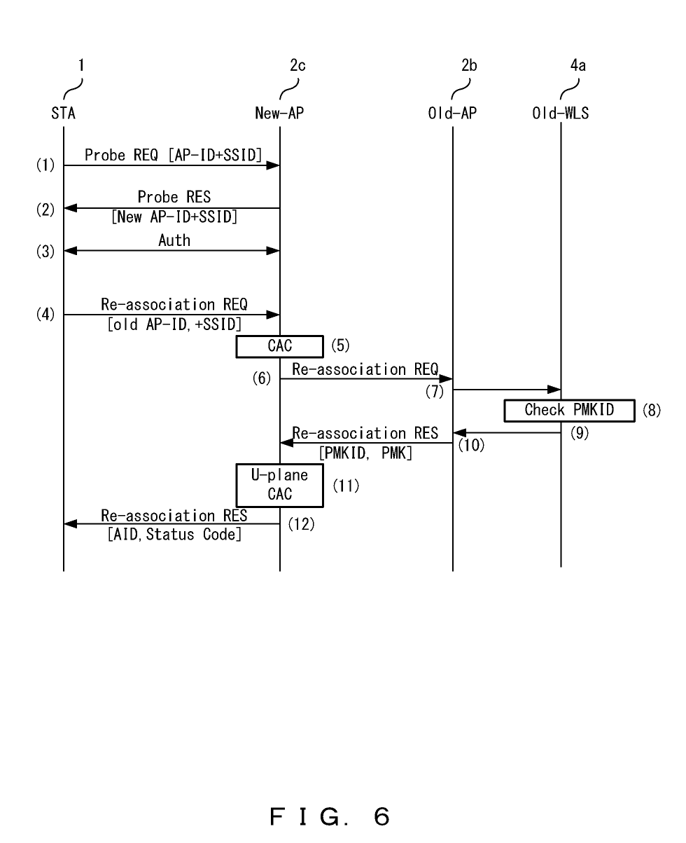

FIG. 6 is a sequence diagram illustrating an example of an embodiment of the handover method used when control information is acquired by a new access point through an old access point. Described below is the handover method according to an embodiment of notifying of the access point identification information using the SSID. Here, the handover is carried out when the mobile station 1 moves from the communication area of the access point 2b to the communication area of the access point 2c.

(1) The mobile station 1 transmits a probe request message to know the communication area of which access point 2 located close to the mobile station 1 when the handover is performed. The transmitted probe request message has an information element similar to that illustrated in FIG. 3, but the configuration of the SSID is the configuration illustrated in FIG. 5B. The mobile station 1 generates a probe request message that stores the access point identification information about the access point 2b connected by the mobile station 1 in the access point identification information field 91. The method of acquiring the access point identification information about the access point 2 connected by the mobile station 1 is described later. The access point 2 including the access point 2c receives the probe request message transmitted from the mobile station 1.

(2) After receiving the probe request message, the access point 2c confirms the information element such as the SSID etc. included in the probe request message, and stores information. For example, it reads the SSID field 92 in the probe request message, and acquires the SSID included in the message transmitted from the mobile station 1.

Using the acquired SSID, the access point 2c determines whether the access of the mobile station 1 is permitted. Each access point 2 is provided with an SSID table recording an accessible SSID. Then, the access point 2c confirms whether the SSID transmitted by the mobile station 1 is included in the SSID table, thereby determining whether the mobile station 1 can access the access point 2c.

The access point 2c can be configured to read the access point identification information field 91 and store access point identification information. In this case, the access point 2b connected by the mobile station 1 can be recognized earlier.

When the access of the mobile station 1 is permitted, the access point 2c can be a new access point 2 of the mobile station 1. Then, the access point 2c transmits a probe response message to the mobile station 1 to notify the mobile station 1 that the mobile station 1 is located in the communication area of access point 2c. The probe response message stores the access point identification information indicating the access point 2c as the access point identification information about the new access point.

Upon receipt of the probe response message, the mobile station 1 reads the access point identification information field 91 and stores the access point identification information about the access point 2c as an access point that can be a new access point.

(3) When the mobile station 1 recognizes the access point 2c by the probe response message, the mobile station 1 and the access point 2c exchange authenticating messages for authentication.

(4) The mobile station 1 transmits a re-association request message after defining the authenticated access point 2c as a new access point. The information element of the re-association request message is illustrated in FIG. 4.

At this time, the mobile station 1 stores the access point identification information about the old access point 2b in the access point identification information field 91 of the SSID included in the re-association request message, and transmits the message to the access point 2c.

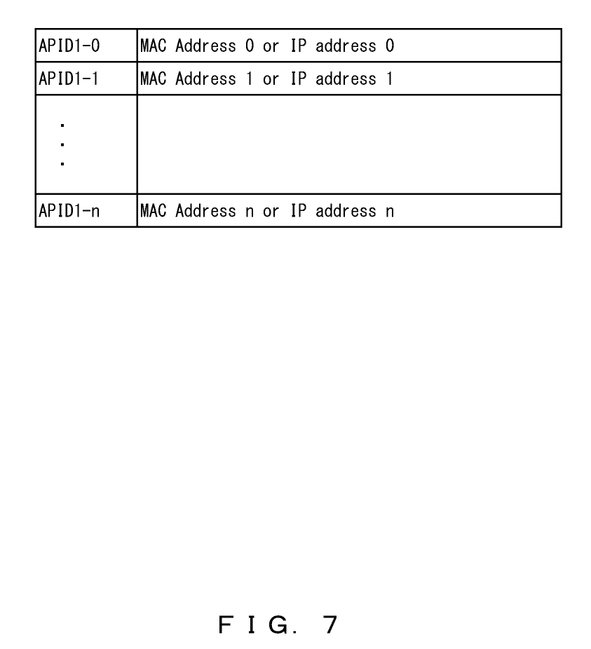

Upon receipt of the re-association request message, the new access point 2c confirms the access point identification information field 91 of the SSID in the message, and extracts access point identification information. The access point 2c searches the AP-ID table stored by itself according to the extracted access point identification information, and accesses the access point 2b currently connected by the mobile station 1 requesting a connection. FIG. 7 is an example of an AP-ID table stored by the access point 2. The AP-ID table stores the access point identification information associated with the MAC address or the IP address of the access point for each access point 2.

For example, if the AP-ID of the access point 2b is “APID 1”, the access point 2c extracts the identification information “APID 1” from the access point identification information field 91. The access point 2c recognizes the MAC address or IP address stored in the AP-ID table and associated with the APID 1 as the address of the old access point 2b.

(5) Upon receipt of a re-association request message, the new access point 2c performs call admission control and confirms whether the number of mobile stations 1 to be connected to the access point 2c can be increased.

(6) When one or more mobile stations can be connected to the access point 2c, the access point 2c transfers a re-association request message to the address of the old access point 2b designated using the AP-ID table. By transferring the re-association request message, the new access point 2c requests the old access point 2b to transmit the control information used for communications with the mobile station 1.

In this specification, requesting the old access point 2b to transmit control information includes requesting another node such as the wireless control device 4a etc. to transmit control information through the old access point 2b. Similarly, acquiring the control information from the old access point 2b includes not only acquiring the control information held by the old access point 2b, but also acquiring the control information held by another node through the old access point 2b.

(7) Upon receipt of the re-association request message from the new access point 2c, the old access point 2b recognizes the handover by the mobile station 1 to the new access point 2c. Thus, the old access point 2b requests the control information stored by the wireless control device 4a managing the old access point 2b to notify the new access point 2c of the control information.

(8) The wireless control device 4a retrieves the PMKID etc. used in the communications with the mobile station 1 at the request from the old access point 2b. The retrieving method in this case can be arbitrarily selected. For example, each wireless control device 4 can be provided with a control information table storing the control information such as the PMKID etc. used in the communication between the subordinate access point 2 and the mobile station 1 associated with the identification information for unique identification of each mobile station 1. When each access point 2 requests the wireless control device 4 to transmit the control information, it notifies the wireless control device 4 of the identification information for unique identification of each mobile station 1, and the wireless control device 4 uses the information to search the table and extract the requested control information. In addition, instead of the identification information for unique identification of each mobile station 1, the identification information can be used for unique identification of the connection between the mobile station 1 and the access point 2 to configure the table of the wireless control devices 4 so that the wireless control device 4 can extract control information.

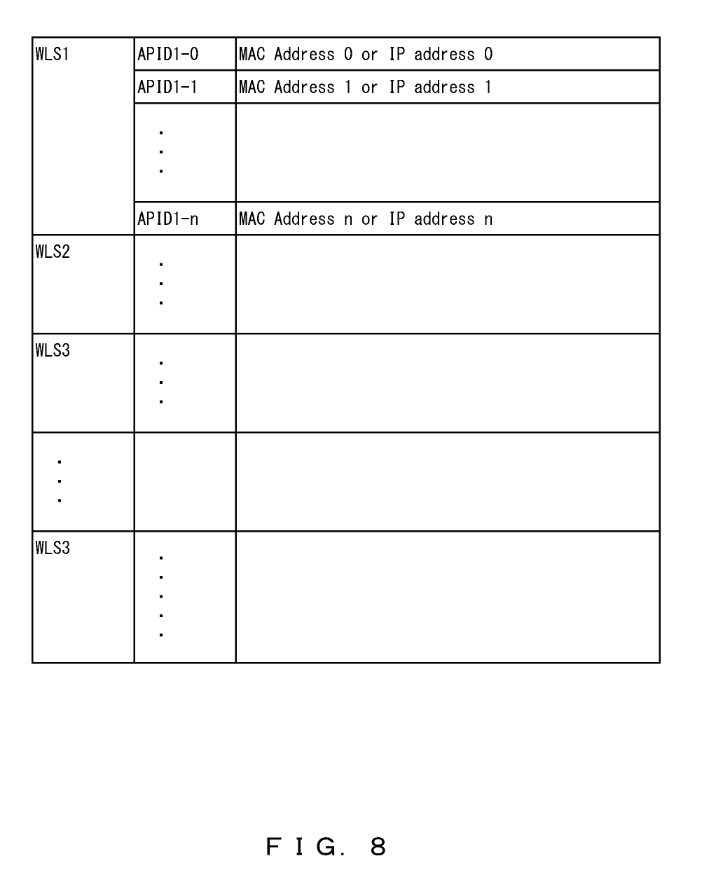

The wireless control device 4 can be configured to have an access point management table recording the access point identification information, the MAC address and IP address of the access point 2 for the access point 2 managed by another wireless control device 4. FIG. 8 is a diagram illustrating an example of the access point management table. When the PMKID is stored as associated with the MAC address or IP address in the wireless control device, the wireless control device 4a retrieves the address of the old access point 2b from the access point management table and extracts the PKMID etc.

(9) The wireless control device 4a notifies the old access point 2b of the control information such as the PMKID, the PMK, etc.

(10) The old access point 2b notifies the new access point 2c of the control information such as the PMKID, the PMK.

(11) The new access point 2c performs the call admission control in the U plane, and confirms whether the number of mobile stations 1 for transmitting and receiving user data can be increased.

(12) When the number of mobile stations 1 for transmitting and receiving user data to and from the new access point 2c can be increased, the new access point 2c transmits a re-association response message to the mobile station 1. The re-association response message includes AID and Stetus Code.

In the above-mentioned handover method, the handover can be performed between the access points connected to different wireless control devices. Therefore, for example, when a wireless LAN is implemented in a corporation, the problem of a communication disconnection by a movement to another floor can be prevented. In addition, even in a large floor configuration, a communication disconnection by a movement of a mobile station can be prevented. In this method, since a new access point retrieves an old access point using each AP-ID table, a load is not imposed on a part of nodes. Furthermore, since a master wireless control device does not retrieve the old access point 2, the handover process can be quickly performed. As described above, even after providing the access point 2 and the wireless control device 4, the AP-ID table of each access point 2 can be updated by updating the access point management table.

The procedure described with reference to FIG. 6 is an example of the handover method for recognizing an old access point using an SSID. Therefore, a change can be made, for example, the designation of the old access point 2b performed in the procedure (4) can be performed after the call admission control performed in the procedure (5). In addition, after establishing the link to the new access point 2c, the mobile station 1 deletes the access point identification information indicating the old access point 2b so that the memory area available in the mobile station 1 can be increased. However, the mobile station 1 stores the access point identification information indicating an old access point until a link to a new access point is established. Therefore, the mobile station 1 can establish a link to another access point 2 using the access point identification information indicating the old access point in the case where the establishment of the link to new access point 2c is failed by the call admission control etc.

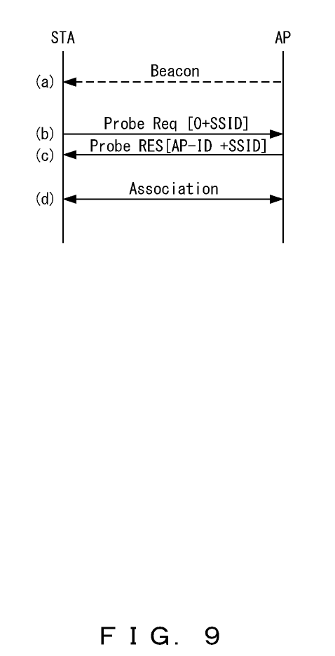

FIG. 9 is a diagram illustrating a method of acquiring access point identification information about an access point to be connected when a mobile station 1 starts communications with a network.

(a) When the mobile station 1 is activated, the mobile station 1 is not connected to any access point 2. On the other hand, the access point 2 periodically transmits a beacon, and notifies the mobile station 1 located in the communication area of the access point 2 that the communication area is close to it. In this case, to enhance the security, the access point 2 can transmit a notification without an SSID in the beacon. In addition, when an SSID is notified through a beacon, the SSID field 9 illustrated in FIG. 5A can be configured as an information element of a beacon not to transmit access point identification information.

(b) On the other hand, the mobile station 1 issues a probe request message to search the peripheral communication area. At this time, since the mobile station 1 is not connected to any access point 2, it issues a probe request message with “0” input to the access point identification information field 91. An SSID is stored in the SSID field 92 of the probe request message.

(c) Upon receipt of the probe request message issued from the mobile station 1, the access point 2 confirms the SSID field 92 as to whether the recorded SSID is included in the SSID table. When the access of the mobile station 1 is permitted, the access point 2 transmits to the mobile station 1 the probe response message storing the access point identification information indicating the access point 2 in the access point identification information field 91. By receiving the probe response message, the mobile station 1 recognizes and stores the access point identification information indicating the access point 2 to which a link is established.

(d) Upon receipt of the probe response message by the mobile station 1, the authentication is performed between the mobile station 1 and the access point 2.

In the above-mentioned procedure, the access point identification information indicating the access point to be first connected by the mobile station 1 is acquired.

Furthermore, even in the network including the access point 2 not compatible with the handover method in which access point identification information is notified, the handover method in which the access point identification information is notified can be used. In this case, in the access point 2 capable of using the handover method in which the access point identification information is notified, the above-mentioned handover can be performed using the access point identification information. However, the operation of the access point 2 not compatible with the handover in which the access point identification information is notified does not interfere with the operation of the access point 2 compatible with the notification of the access point identification information. For example, the mobile station 1 compatible with the handover method in which the access point identification information is notified using the above-mentioned SSID can also perform the handover of the access point not compatible with the method as a new access point. An example of the operation in this case is described below.

First, the mobile station 1 transmits to the access point 2 a probe request message storing the access point identification information in the access point identification information field 91. When the new access point 2 is not compatible with the handover method in which the access point identification information is used, the new access point 2 cannot read the SSID of the mobile station 1. In this case, the new access point 2 transmits an error message to the mobile station 1 or returns no response.

The mobile station 1 waits for a probe response message from the access point 2 for a predetermined time. If an error message is received from the access point 2, or the new access point 2 does not answer the probe request message, then the mobile station 1 cannot receive a probe response message within the predetermined time. The mobile station 1 transmits to the new access point 2 a probe request message including no access point identification information using the SSID illustrated in FIG. 5A as an information element. Then, the new access point 2 can read the SSID field 9 illustrated in FIG. 5A, and transmits a probe response message to the mobile station 1.

Upon receipt of the probe response message after the transmission of the probe request message including no access point identification information, the mobile station 1 determines that the new access point 2 is not compatible with the handover method using the access point identification information. Then, the re-association request message does not include access point identification information using the SSID as illustrated in FIG. 5A as an information element.

Thus, even in the network including the access point 2 not compatible with the notification of access point identification information, the access point not compatible with the notification of the access point identification information does not interfere with the handover. That is, the mobile station 1 can be used in a network including an access point not compatible with the handover method using access point identification information by changing the configuration of the message transmitted by the mobile station 1 depending on the new access point.

<Device Configuration>

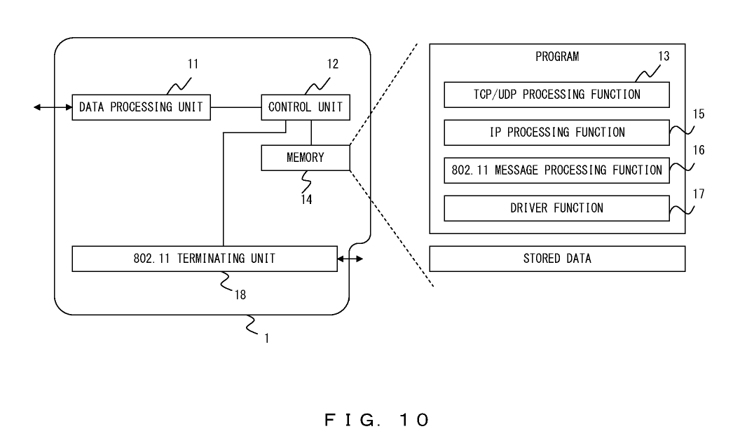

FIG. 10 is a diagram illustrating an example of the configuration of the mobile station 1 compatible with the handover method according to the above-mentioned embodiment of the present invention. The mobile station 1 includes a data processing unit 11, a control unit 12, memory 14, and an 802.11 terminating unit 18. The memory 14 stores data, a program, etc. And a TCP/UDP processing function 13, an IP processing function 15, an 802.11 message processing function 16, and a driver function 17 are realized by the control unit 12 reading the program stored in the memory 14.

The data processing unit 11 processes the data received by the mobile station 1 through the access point 2. It also processes the data transmitted by the mobile station 1 to the access point 2.

The control unit 12 controls the above-mentioned handover method. The control unit 12 stores the access point identification information in the memory 14, and extracts access point identification information and an SSID from the control message received by the mobile station 1. It also controls the transmission of a control message such as a re-association request message etc.

The TCP/UDP processing function 13 controls the transmission and reception of the data using a TCP protocol and a UDP protocol. The memory 14 stores the access point identification information about a new access point and an old access point at a request from the control unit 12. In addition, it appropriately stores the information stored in the mobile station 1, for example, an SSID extracted from the probe response message etc. The IP processing function 15 controls the transmission and reception of data using the IP protocol.

The 802.11 message processing function 16 controls the communication by the wireless LAN in accordance with the 802.11 standard. Additionally, the software for operating the devices incorporated into the mobile station 1 and the peripheral devices of the mobile station 1 is also stored in the memory 14, and the driver function 17 is provided using them. The 802.11 terminating unit 18 terminates the communication by the wireless LAN in accordance with the 802.11 standard.

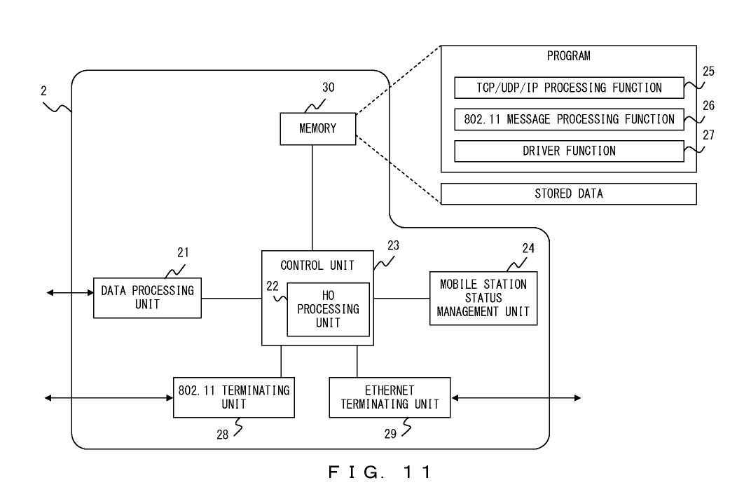

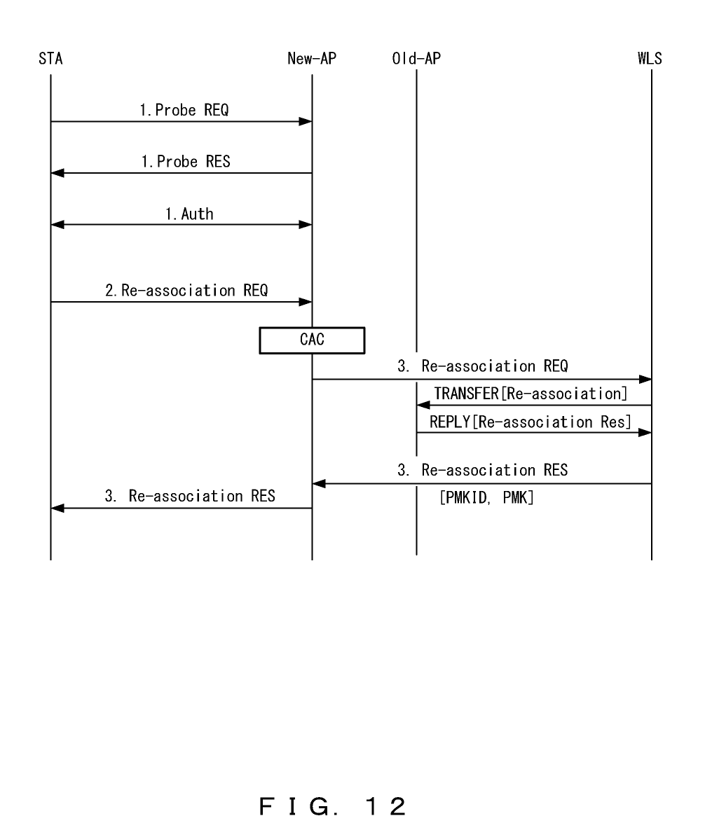

FIG. 11 is a diagram illustrating an example of the configuration of an access point 2 compatible with the handover method according to the above-mentioned embodiment of the present invention. The access point 2 includes a data processing unit 21, a handover processing unit (HO processing unit) 22, a control unit 23, a mobile station status management unit 24, an 802.11 terminating unit 28, an Ethernet terminating unit 29, and memory 30. The memory 30 stores data, a program, etc., and a TCP/UDP/IP processing function 25, an 802.11 message processing function 26, and a driver function 27 are provided by the control unit 23 reading the program stored in the memory 14.

The data processing unit 21 processes the communication data received by the access point 2 from the mobile station 1. It also processes the data transmitted from the access point 2 to the mobile station 1.

The handover processing unit 22 controls the above-mentioned handover method by transmitting access point identification information to the mobile station 1, notifying an AID, etc. Furthermore, it designates an old access point using the re-association request message transmitted from the mobile station 1, and requests the old access point 2 to transmit control information for establishing a link to the mobile station 1. The AP-ID table and the SSID table can be provided in the handover processing unit 22.

The control unit 23 includes the handover processing unit 22. The components such as the data processing unit 21, the mobile station status management unit 24, etc. other than the handover processing unit 22 control each portion included in the access point 2. The mobile station status management unit 24 manages the state of the mobile station 1 connected to the access point 2. The TCP/UDP/IP processing function 25 controls the transmission and reception of data using the TCP protocol, the UDP protocol, and the IP protocol.

The 802.11 message processing function 26 controls the communications by a wireless LAN in accordance with the 802.11 standard. The software for operating the devices incorporated into the access point 2 and the peripheral devices of the access point 2 is stored in the memory 30, and the driver function 27 is realized using the software. The 802.11 terminating unit 28 terminates the communications by the wireless LAN in accordance with the 802.11. The Ethernet terminating unit 29 terminates the communications in accordance with the Ethernet (registered trademark) standard.

The embodiment of the handover method according to the access point identification information is not limited to the above-mentioned embodiment, but can be variable in many ways. For example, the access point 2 can process the SSID field 92 at the probe request message received from the mobile station 1 and mask the access point identification information field 91. The mobile station 1 does not transmit the re-association request message to all access points 2. When the re-association request message is not received, access point 2 does not refer the access point identification information field 91. Therefore, access point 2 does not store access point identification information etc., thereby the load of the access point 2 is reduced.

In addition, the mobile station 1 can be configured not to transmit access point identification information when a probe request message is transmitted. In this case, the SSID field 9 illustrated in FIG. 5A can be used in the probe request message. By configuring the mobile station 1 not to notify another node of the access point identification information until the stage of transmitting the re-association request message, the security can be enhanced. In this case, since the access point 2 that has received the probe request message dose not process the access point identification information field 91, the load of the access point 2 can be reduced.

As described above, in each of the above-mentioned embodiments, a mobile station moving from the communication area of the first access point to the communication area of the second access point transmits a connection request message to the second access point. The access point identification information identifying the first access point is included in the connection request message. Using the access point identification information, the second access point requests the first access point to transmit control information for the communications with the mobile station. Upon receipt of the control information, the second access point establishes a link to the mobile station using the control information.

By applying the system, the handover can be performed between the access points connected to different wireless control devices.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention has(have) been described in detail, it should be understood that the various changes, substitutions, and alterations could be made hereto without departing from the spirit and scope of the invention.

What is claimed is:

1. A record medium storing, when a mobile station moves from a communication area of a first access point to a communication area of a second access point, a communication control program used to direct an information processing device provided for the second access point to function as:
an extraction device to extract first access point identification information identifying the first access point from a connection request message received from the mobile station;
a request device to request the first access point to transmit control information relating to a communication of the mobile station using the first access point identification information; and
a communication device to establish a link to the mobile station using the control information acquired from the first access point.

2. The medium according to claim 1, wherein
the request device designates the first access point with reference to an access point record table recording access point identification information for identification of an access point forming a communication area adjacent to the communication area of the second access point.

3. The medium according to claim 1, wherein
when a control message transmitted from the mobile station is a message inquiring whether the mobile station is located in the communication area of the second access point, the communication device determines possibility of a connection between the mobile station and the second access point.

4. The medium according to claim 1, wherein
the information processing device provided for the second access point is directed to further function as
an identification information notification device to notify the mobile station of second access point identification information identifying the second access point using a message in response to an inquiry message as to presence of an access point transmitted from the mobile station.

5. The medium according to claim 1, wherein
an identification information of an access point is stored in a service set identifier field defined by IEEE 802.11.

6. An apparatus used for an access point used, in a system having a first access point and a second access point, as the second access point, comprising:
an identification information extraction device to extract, upon receipt of a connection request message from a mobile station moving from a communication area of the first access point to a communication area of the second access point, first access point identification information identifying the first access point from the connection request message;
a control information request device to request the first access point to transmit control information relating to a communication of the mobile station using the first access point identification information; and
a communication device to establish a link to the mobile station using the control information acquired from the first access point.

7. The apparatus according to claim 6, wherein:
the second access point is connected to a second wireless control device different from a first wireless control device to which the first access point is connected; and
the first wireless control device manages control information used in a communication between the first access point and the mobile station.

8. The apparatus according to claim 6, further comprising
an access point record table to record access point identification information identifying an access point forming a communication area adjacent to the communication area of the second access point, wherein
the control information request device refers to the access point record table, and requests the first access point to transmit the control information when the first access point identification information is included in the access point record table.

9. The apparatus according to claim 6, wherein
when a control message transmitted from the mobile station is a message inquiring whether the mobile station is located in the communication area of the second access point, the communication device determines possibility of a connection between the mobile station and the second access point.

10. A record medium storing, when a mobile station moves from a communication area of a first access point to a communication area of a second access point, a communication control program used to direct an information processing device provided for the mobile station to function as:
an identification information storage device to store first access point identification information identifying the first access point;
an extraction device to extract, when the mobile station receives from the second access point a second message in response to a first message inquiring whether the mobile station is located in a communication area of an access point, access point identification information identifying the second access point from the second message; and
a transmission device to transmit a third message including the first access point identification information to the second access point.

11. The medium according to claim 10, wherein
when a control message transmitted from the second access point to establish a link between the mobile station and the second access point is not the second message, the mobile station does not define an area storing the second access point identification information in the control information as a process target.

12. A mobile station performing a communication using a connection to an access point, comprising:
an identification information storage device to store first access point identification information identifying the first access point;
an identification information extraction device to extract, when the mobile station receives from a second access point a second message in response to a first message inquiring whether the mobile station is located in a communication area of the access point, access point identification information identifying the second access point from the second message; and
a transmission device to transmit a third message including the first access point identification information to the second access point.

13. The mobile station according to claim 12, wherein
when a control message transmitted from the second access point to establish a link between the mobile station and the second access point is not the second message, an area storing the second access point identification information in the control information is not defined as a process target.

14. A wireless communication system, comprising:
a plurality of access points including a first access point and a second access point, wherein each access point transmits a first message including access point identification information identifying relevant access point; and
a mobile station that acquires access point identification information about an access point to which a link is established from the first message, wherein
when the mobile station moves from a communication area of a first access point to a communication area of a second access point, the mobile station transmits a second message including first access point identification information to the second access point;
The second access point requests the first access point to transmit control information relating to a communication between the first access point and the mobile station using access point identification information about a first access point extracted from the second message; and
the second access point establishes a link to the mobile station using the control information.

15. A handover method used when a second access point is connected to a second wireless control device different from a first wireless control device to which a first access point is connected, and a mobile station moves from a communication area of the first access point to a communication area of the second access point, comprising:
the second access point notifying the mobile station storing first access point identification information identifying the first access point of a message including second access point identification information identifying the second access point;
the mobile station transmitting a message storing the first access point identification information to the second access point when requesting a connection to the second access point;
the second access point requesting the first wireless control device to transmit control information relating to a communication of the mobile station using the first access point identification information; and
the second access point establishing a link to the mobile station using the control information acquired from the first wireless control device.

16. The method according to claim 15, wherein:
the second access point requests control information relating to a communication of the mobile station through the first access point designated according to the first access point identification information; and
the control information is acquired through the first access point to establish a link to the mobile station.

17. The method according to claim 16, wherein
the second access point identification information is extracted from a second message transmitted by the second access point to the mobile station in response to a first message transmitted to inquire whether the mobile station is located in a communication area of an access point.
